(19) United States
(12) Patent Application Publication
(10) Pub. No.: US 2013/0029612 A1
(43) Pub. Date: Jan. 31, 2013

(54) WIRELESS COMMUNICATION SYSTEM

(71) Applicants: Hiroki Mochizuki, Shizuoka-ken (JP); Nobuo Murofushi, Shizuoka-ken (JP); Hirotaka Ichiba, Shizuoka-ken (JP); Katsumi Gocho, Shizuoka-ken (JP); Koji Terahara, Shizuoka-ken (JP); Kaoru Matsuhisa, Shizuoka-ken (JP); Wataru Sakurai, Shizuoka-ken (JP); Chikashi Gotou, Kanagawa-ken (JP); Tomonori Sugiyama, Kanagawa-ken (JP); Mamoru Nomura, Kanagawa-ken (JP); Shigeru Sato, Kanagawa-ken (JP); Kazuhiro Odoko, Shizuoka-ken (JP); Kanya Hiroi, Kanagawa-ken (JP)

(72) Inventors: Hiroki Mochizuki, Shizuoka-ken (JP); Nobuo Murofushi, Shizuoka-ken (JP); Hirotaka Ichiba, Shizuoka-ken (JP); Katsumi Gocho, Shizuoka-ken (JP); Koji Terahara, Shizuoka-ken (JP); Kaoru Matsuhisa, Shizuoka-ken (JP); Wataru Sakurai, Shizuoka-ken (JP); Chikashi Gotou, Kanagawa-ken (JP); Tomonori Sugiyama, Kanagawa-ken (JP); Mamoru Nomura, Kanagawa-ken (JP); Shigeru Sato, Kanagawa-ken (JP); Kazuhiro Odoko, Shizuoka-ken (JP); Kanya Hiroi, Kanagawa-ken (JP)

(73) Assignee: TOSHIBA TEC KABUSHIKI KAISHA, Tokyo (JP)

(21) Appl. No.: 13/553,935

(22) Filed: Jul. 20, 2012

(30) Foreign Application Priority Data
Jul. 28, 2011 (JP) 2011-165897

(51) Int. Cl. H04B 1/38

(52) U.S. Cl. 455/73

(57) ABSTRACT

According to one embodiment, a wireless communication system comprises a leaky coaxial cable configured to send and receive electric wave to and from a wireless communication terminal and a retainer member configured to vertically arrange the leaky coaxial cable on a given setting surface.

### CROSS-REFERENCE TO RELATED APPLICATION

This application is based upon and claims the benefit of priority from Japanese Patent Application No. 2011-165897, filed Jul. 28, 2011, the entire contents of which are incorporated herein by reference.

### FIELD

Embodiments described herein relate to a wireless communication system using a leaky coaxial cable (LCC).

### BACKGROUND

A wireless communication system using an LCX cable has been popularized in many fields in recent years.

An LCX cable is a cable having, on the external conductor of the coaxial cable thereof, a plurality of small holes which are referred to as slots and serve as a transmitter antenna, thus, the cable wholly becomes an antenna radiating in a direction.

The LCX cable is characterized in that a communication area is formed nearby the cable in the length direction of the cable. By using the characteristic flexibly, a wireless communication system using the LCX cable becomes a unique system which eliminates the contradiction between the prevention of the wiretap of communication content (security) from a location away from the LCX cable and the allowable free configuration and movement (mobility) of a client terminal in a communication area.

### BRIEF DESCRIPTION OF THE DRAWINGS

FIG. 1 is a schematic diagram roughly showing the structure of the wireless communication system shared in the embodiments;

FIG. 2 is a diagram showing the LCX cable of the system;

FIG. 3 is a diagram showing the structure of the controller or LCX electrode of the system;

FIG. 4 is a diagram illustrating a use mode used in the first embodiment;

FIG. 5 is a flow chart showing the basic actions carried out by a controller unit in the first embodiment;

FIG. 6 is a diagram illustrating a use mode used in the second embodiment;

FIG. 7 is a flow chart showing the basic actions carried out by a controller unit in the second embodiment;

FIG. 8 is a flow chart showing the actions carried out by a controller unit to dispense a coupon in the second embodiment;

FIG. 9 is a diagram illustrating a use mode used in the third embodiment;

FIG. 10 is a flow chart showing the actions carried out by a controller unit to send the printed data in the third embodiment;

FIG. 11 is a flow chart showing the basic actions carried out by a controller unit in the fourth embodiment.

### DETAILED DESCRIPTION

According to one embodiment, a wireless communication system comprises a leaky coaxial cable configured to send and receive electric wave to and from a wireless communication terminal and a retainer member configured to vertically arrange the leaky coaxial cable on a given setting surface.

Embodiments of the present invention are described below with reference to accompanying drawings.

The members shared in the embodiments are described prior to those distinguishing the embodiments.

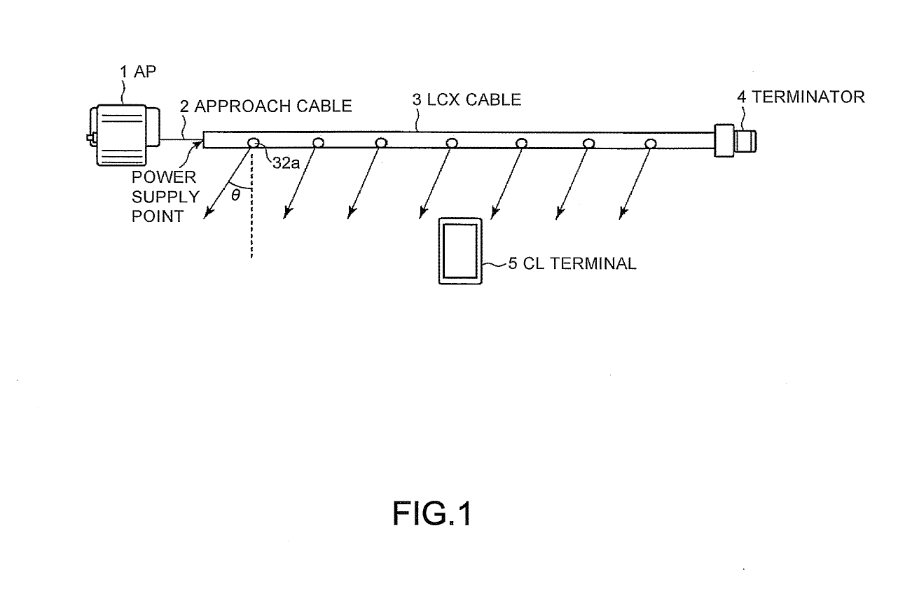

FIG. 1 is a schematic diagram roughly showing the structure of the wireless communication system shared in the embodiments.

The wireless communication system comprises: an access point (AP) 1 serving as a base station, an approach cable 2, an LCX cable 3 and a terminator 4. The wireless communication system forwards the communication between client terminals (CL) 5 such as notebook personal computers (PC) or PDAs or between the client terminal 5 and a machine connected with a network such as the Internet.

The access point 1 modulates the sent data to generate a high-frequency sending signal, amplifies the generated sending signal using a power amplifier (PA) and sends the amplified signal to the LCX cable 3, synchronously, the access point 1 also demodulates the signal output from the LCX cable 3 to generate receiving data. Moreover, the access point 1 comprises a mechanism for adjusting a sending output (sending power) by changing a target signal amplification value based on the PA according to, for example, the operation of an operation unit arranged at the access point 1 or an instruction from an external machine.

Two ends of the approach cable 2 are respectively connected with the access point 1 and the LCX cable 3 through a connector (not shown).

The terminator 4, a device for preventing a signal reflection from the terminal part of the LCX cable 3, is connected, through a connector (not shown), with the end of the LCX cable 3 that is not connected with the approach cable 2.

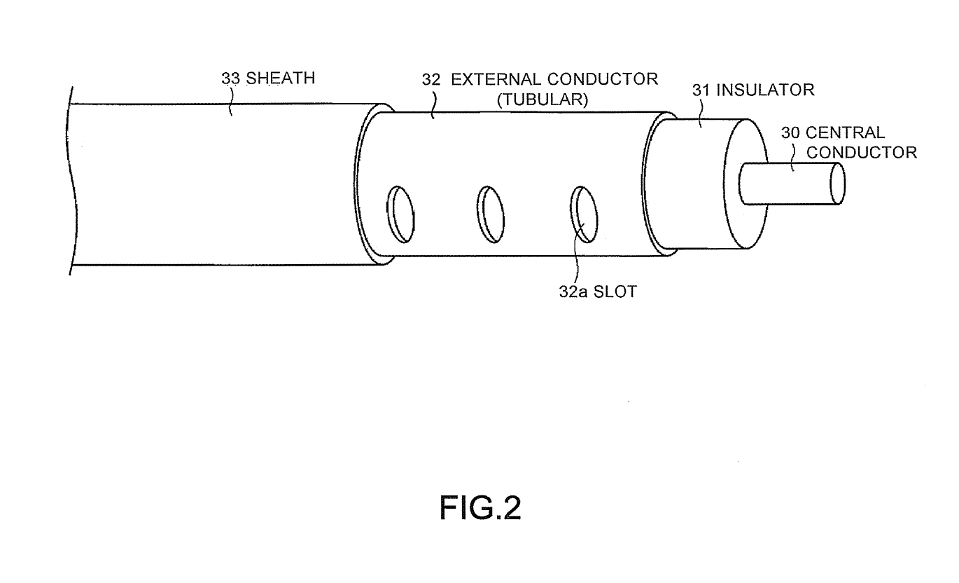

As shown in FIG. 2, the LCX cable 3 comprises: a central conductor 30, which is, for example, a copper line that is arranged in the center of the LCX cable with a circular section; an insulator 31, which is made from, for example, polyethylene and covered on the outer side of the central conductor 30; an external conductor 31, which is made of, for example, tubular aluminum, and covered on the outer side of the insulator 31; and a sheath 32, which is made from, for example, black polyethylene, and covered on the outer side of the external conductor 32.

A plurality of given-shape slots 32a are arranged on the external conductor 32. Moreover, the slots 32A hidden below the sheath 33 are shown in FIG. 1 schematically but not shown one by one. Each slot 32a is an opened hole which serves as an antenna for sending and receiving electric wave with the client terminal 5 and the configuration space of which is adjusted corresponding to the length of the electric wave used by the wireless communication system. As a result, the whole LCX cable 3 acts like an array antenna, a communication area such that every point on the area is substantially equidistant from the LCX cable 3 along the length direction of the LCX cable 3 is formed.

The transmission direction of electric wave only is inclined towards the LCX cable 3 by a given angle corresponding to the shape of the slot holes 32a or the space between the slot holes 32a. The example shown in FIG. 1 illustrates an example of the so-called ‘backfire’, that is, the transmission direction (indicated by the arrow shown in FIG. 1) of electric wave is inclined towards the connection point (power supply point) of the approach cable 2 and the LCX cable 3 by an angle θ(0<θ<90).

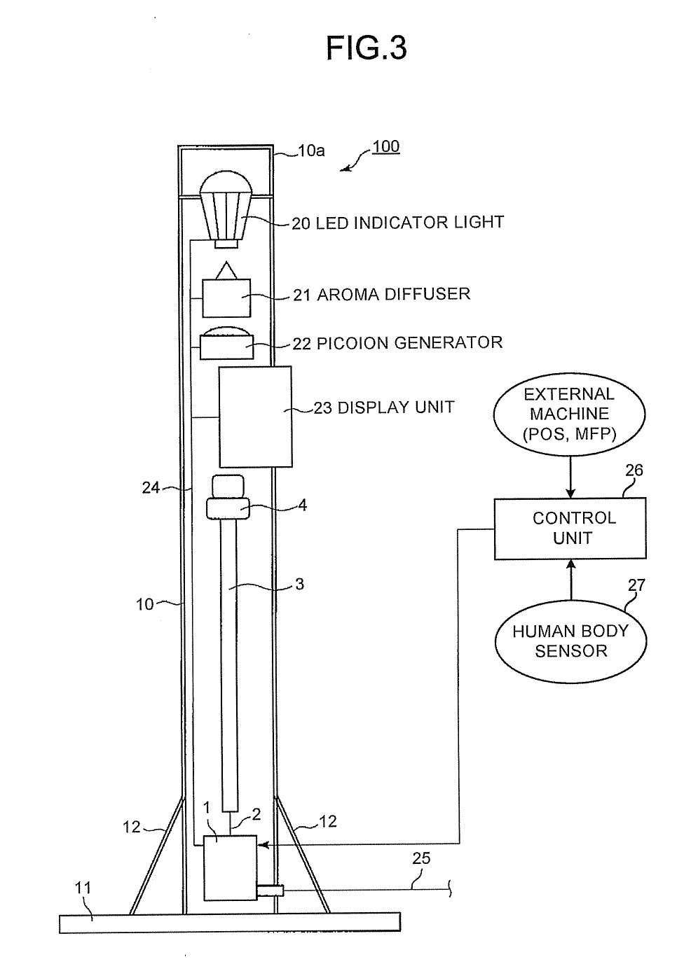

In embodiments, the access point 1, the approach cable 2, the LCX cable 3 and the terminator 4 are stored in a hollow cylindrical cover member 10, as shown in FIG. 3. The LCX cable 3 is expanded in the cover member by, for example, fixing the terminal 4 as well as the end of LCX cable 3 connected with the approach cable 2 on the inner wall of the cover member 10. A messenger wire is mounted on the sheath 33 of the LCX cable 3, thus, the LCX cable 3 can be designed to be expanded linearly.

A support base unit 11 is mounted below the cover member 10. The plane of the support base unit 11 is substantially vertical to the length direction of the cover member 10. Besides, a pyramidal support member 12 surrounding the cover member 10 is arranged nearby the part where the cover member is fixed on the support base part. Under the effect of the support member 12, the cover member 10 is stably arranged vertical to the plane of the support base unit 11.

With respect to a setting surface such as a table 6 or floor surface that will be described later, the support base unit 11 is placed in such a manner that the plane of the side of the support base unit 11 without the cover member 10 is contacted with the setting surface. In this way, the cover member 10 is vertically arranged on the setting surface so that the axial direction of the LCX cable 3 stored in the cover member 10 is vertical to the setting surface.

The cover member 10, the support base unit 11 and the support member 12 together constitute a retainer member for retaining the LCX cable 3. The cover member 10 and the support member 12 are made from a nonconductive material with low dielectric constant, for example, plastic, causing no interference to the wireless communication between the LCX cable 3 and the client terminal 5. On the other hand, the support base unit 11 is made from a heavy material, for example, a metal material, so as to support the stable vertical arrangement of the cover member 10.

In addition to the LCX cable 3, an LED indicator light 20, an aroma diffuser 21, a Picoion generator 22 and a display 23 are also arranged on the cover member 10.

The LED indicator light 20 consisting of a plurality of LEDs is arranged on the upper end 10a of the cover member 10 which is made from a transparent or semi-transparent material so that the light given off by the LED indicator light 20 can be seen from the outside of the cover member 10. The LED indicator light 20 is responsible for informing the user of the action state of the wireless communication system as well as the illumination for the surroundings.

The aroma diffuser 21, which is arranged inside the cover member 10 to increase the pressure of air using, for example, a pump, changes essential oil to particles (mist) through an air-using capillarity phenomenon, and then sprays the mist to the surroundings of the cover member 10 through one or more openings arranged on the cover member 10.

The Picoion generator 22 arranged in the cover member 10 applies a high voltage to a water-holding Picoion discharging hole to decompose water into hydrogen and OH free radical with high oxidability, wraps the OH free radical with fine water drop, and discharges the water drop to the surroundings of the cover member 10 through one or more openings arranged on the cover member 10.

The display 23, which is, for example, an LCD, is arranged on the outer wall of the cover member 10, with the display panel facing a user-recognizable direction, depending upon the use mode of the wireless communication system.

The LED indicator light 20, the aroma diffuser 21, the Picoion generator 22 and the display 23 are connected with the access point 1 via a control/power line 24 running through the cover member 10.

An LAN line 25 is connected with the access point 1 to realize the connection between the wireless communication system and a given server or the Internet.

The access point 1 connects/disconnects the power supply to the LCX cable 3, the LED indicator light 20, the aroma diffuser 21, the Picoion generator 22 and the display 23 according to an instruction sent from a controller unit 26. With respect to the access point 1, the controller unit 26 may be the Central Processing Unit (CPU) or memory of a computer connected through the LAN line 25 or the CPU or memory of the access point 1.

An external machine such as a POS (Point of Sales) terminal or MFP (the called combination machine) or a human body sensor 27 is connected with the controller unit 26. The human body sensor 27 is a sensor detecting the existence of a person at a given position or in a given area using infrared rays, ultrasonic wave or visible rays.

By executing the computer program stored in the memory of the controller unit 2 with a CPU, the controller unit 26 realizes the following functions:

(1) control one or more devices, that is, control the actions of the LCX cable 3, the LED indicator light 20, the aroma diffuser 21, the Picoion generator 22 and the display 23, according to the detection result of the human body sensor 27.

(2) control the actions of the one or more devices according to the use condition of an external machine.

Embodiments 1-4 are illustrated based on the above-described structure.

In the following description, the cover member 10, the support base unit 11, the support member 12 and the units stored or fixed in the cover member 10 are combined and uniformly referred to as an LCX electrode 100.

### The First Embodiment

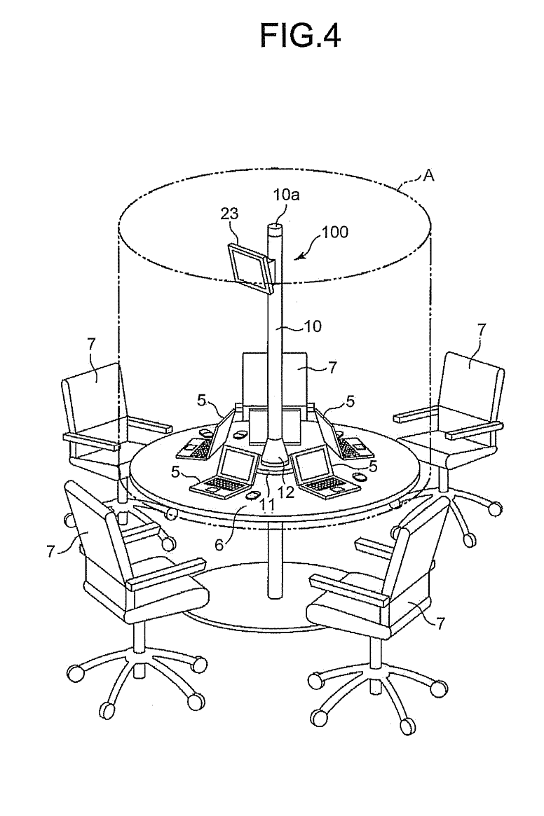

In the first embodiment, the LCX electrode 100 is vertically arranged on a table in an office or shop, and each device of the LCX electrode 100 is driven according to the detection result of the human body sensor 27, as exemplarily shown in FIG. 4.

In the example shown in FIG. 4, the LCX electrode 100 is vertically arranged in the center of a circular table 6 with respect to the setting surface of the table 6, and a communication area A is adjusted to cover the whole table 6. When used in this case, client terminals 5 such as a notebook PC placed on the table 6 or a handwriting PC hold by the people sitting on a chair 7 can wirelessly connect with other client terminals 5 or the Internet.

The human body sensor 27 is pre-arranged to detect the people sitting on the chairs 7 placed surrounding the table 6.

The actions of the controller 26 are described below.

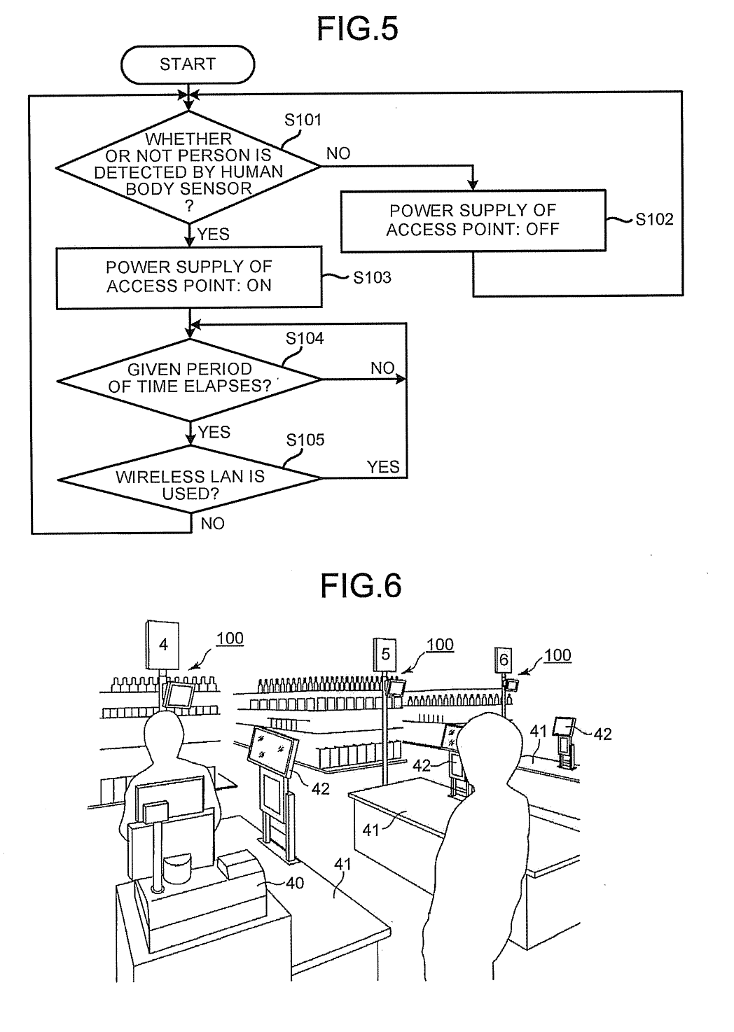

FIG. 5 is a flow chart showing the actions carried out by the controller unit 26 in this embodiment.

As shown in FIG. 5, first, the controller unit 26 determines whether or not a person is detected by the human body sensor 27 (Act S101). If no person is detected by the human body sensor 27 (S101: No), the controller unit 26 switches off the power supply of the access point 1 (Act S102) and returns to execute Act S101.

On the other hand, if a person is detected by the human body sensor 27 (S101: Yes), the controller unit 26 switches on the power supply of the access point 1 (Act S102) and returns to execute Act S101. After powered on, the access point 1 starts to supply power to the LCX cable 3, the LED indicator light 20, the aroma diffuser 21, the Picoion generator 22 and the display 23. In this way, the client terminals 5 around the table 6 can wirelessly communicate with each other through the LCX cable 3, the LED indicator light 20 is turned on, the aroma diffuser 21 sprays essential oil to the surroundings, the Picoion generator 22 generates Picoions, and the display 23 displays various kinds of information.

The users around the table 6 can recognize the usable wireless LAN provided by the LCX electrode 100 by observing the turned-on LED indicator light 20. In addition, the users can be relaxed by the sprayed essential oil, and air can be purified by the generated Picoions. News, weather forecast and advertisement information can be displayed on the display unit 23.

After the power supply of the access point 1 is switched on, the controller unit 26 waits for a given period of time (e.g. 1 min) with reference to the time timed by a timer (not shown) (Act S104: No). After the given period of time elapses (Act S104: Yes), the controller unit 26 determines whether or not a wireless LAN is used (Act S105). The determination may also be carried out by determining whether or not a communication with the client terminals 5 is implemented during the given period of time.

If a wireless LAN is used (Act S105: Yes), the controller unit 26 waits for the given period of time again (Act S104: No).

If no wireless LAN is used (Act S105: No), the controller unit 26 returns to execute Act S101 to re-determine whether or not a person is detected by the human body sensor 27, and switches off the power supply of the access point (Act S102) if no person is detected by the human body sensor 27 (Act S101: No). Thus, the wireless LAN cannot be used, the LED indicator light 20 is extinguished, the spray of essential oil from the aroma diffuser 21 is stopped, the discharge of Picoions from the Picoion generator 22 is eliminated, and the display 23 is turned off.

In this way, it is assumed in this embodiment that each device of the LCX electrode 100 is driven when a person is detected by the human body sensor 27. As the LCX electrode 100 only acts when needed, the purpose of saving power is achieved.

As no electric wave is radiated from the LCX cable 3 when there is no need for the electric wave, the interference to other wireless LANs is reduced or prevented.

By observing the state of the LED indicator light 20, it can be instantly determined whether or not a wireless LAN can be used around the LCX electrode 100.

A comfortable space is provided by the aroma diffuser 21, the Picoion generator 22 and the display 23.

### The Second Embodiment

The second embodiment is described below.

In this embodiment, the LCX electrode 100 is arranged nearby a cash register in a supermarket or shop, and each device of the LCX electrode 100 is driven according to the detection result of the human body sensor 27 or the action condition of a POS terminal 40, as exemplarily shown in FIG. 6.

The LCX electrode 100 is vertically arranged in an area where people wait in a queue for a checkout, for instance, the LCX electrode 100 is vertically arranged on a floor surface at the entrance side of a checkout counter 41 adjacent to the POS terminal 40. In addition, the human body sensor 27 is pre-arranged to detect the people queuing at the entrance side of the checkout counter 41.

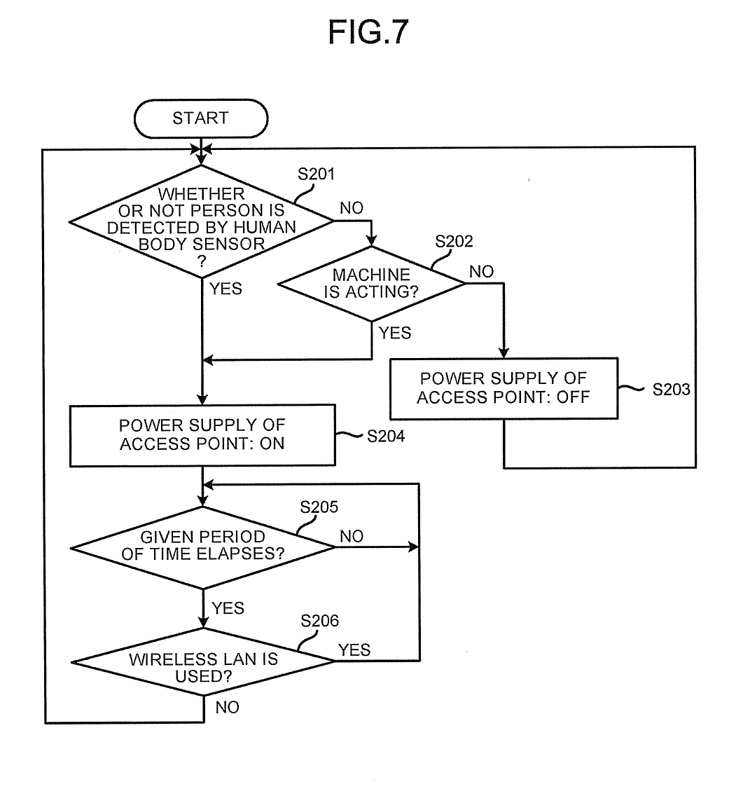

FIG. 7 is a flow chart showing the actions carried out by the controller unit 26 in this embodiment.

As shown in FIG. 7, first, the controller unit 26 determines whether or not a person is detected by the human body sensor 27 (Act S201). If no people is detected by the human body sensor 27 (S201: No), the controller unit 26 determines whether or not a checkout processing is being carried out by an external machine, that is, the POS terminal 41 (Act S202). The checkout processing is started by, for example, an operation on the PLU (Price Look Up) key of a scanner 42 connected with the POS terminal 40. Then, the data of the commodities to be purchased by a customer is registered by the POS terminal 40 or scanner 42, or the checkout processing is ended if the data-registered commodity is settled with cash. The determination of Act 202 may also be carried out according to whether or not a notice is received that is sent from the POS terminal 40 to notify the controller unit 26 to start or end a checkout processing.

If no checkout processing is being carried out (S202: No), the controller unit 26 switches off the power supply of the access point 1 (Act S203) and returns to execute Act S201.

If a person is detected by the human body sensor 27 (S201: Yes) and a checkout processing is being carried out by the POS terminal 40 (Act 202: Yes), the controller unit 26 switches on the power supply of the access point 1 (Act S204). After powered on, the access point 1 starts to supply power to the LCX cable 3, the LED indicator light 20, the aroma diffuser 21, the Picoion generator 22 and the display 23. In this way, the client terminals 5 hold by the customers waiting for a checkout can lighten the LED indicator light 20 through a wireless communication with the LCX cable 3, the aroma diffuser 21 sprays essential oil to the surroundings, the Picoion generator 22 generates Picoions, and the display 23 displays various kinds of information.

After the power supply of the access point 1 is switched on, the controller unit 26 waits for a given period of time (e.g. 1 min) with reference to the time timed by a timer (not shown) (Act S205: No). After the given period of time elapses (S205 Yes), the controller unit 26 determines whether or not a wireless LAN is used (Act S206). The determination may also be carried out by determining whether or not a communication with the client terminals 5 is realized during the given period of time.

If a wireless LAN is used (Act S206: Yes), the controller unit 26 waits for the given period of time again (Act S205: No).

If no wireless LAN is used (S206: No), the controller unit 26 returns to execute Act S201. At this time, if no people is detected by the human body sensor 27 (S201: No) and no checkout processing is being carried out by the POS terminal 40 (Act 202: No), the controller unit 26 switches off the power supply of the access point 1 (Act S203). Thus, the wireless LAN cannot be used, the LED indicator light 20 is turned off, the spray of essential oil from the aroma diffuser 21 is stopped, the discharge of Picoions from the Picoion generator 22 is eliminated, and the display 23 is turned off.

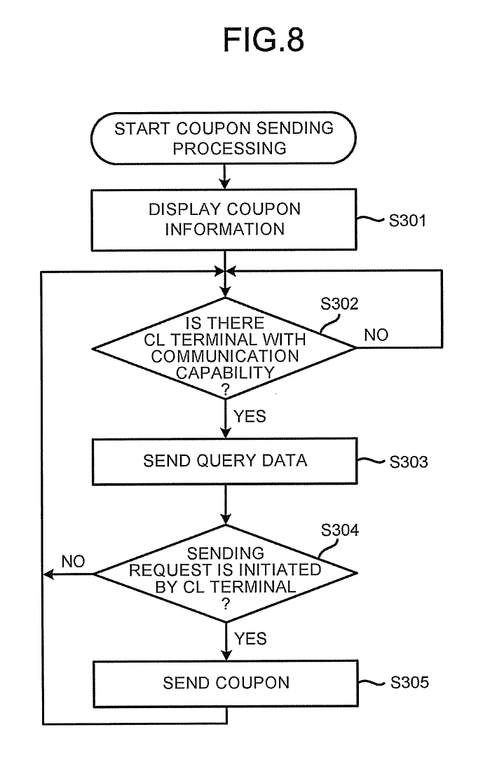

In this embodiment, the coupon dispense processing shown in the flow chart of FIG. 8 is carried out by the controller unit 2 when the power supply of the access point 1 is switched on.

In the coupon dispense processing, first, the controller unit 2 displays coupon information on a display 23 (Act S301), the coupon information being, for example, information representing a discount for a given commodity.

Then, the controller unit 26 confirms the communication condition of the access point 1, and determines whether or not there is a client terminal 5 that can wirelessly communicate with the LCX cable 3 via the access point 1 (Act S302). In this determination, for instance, assume a beacon is sent from the LCX cable 3, the existence of a client terminal 5 capable of carrying out a wireless communication can be determined if a response to the beacon is obtained from the client terminal 5, otherwise, the absence of such a client terminal can be determined.

If there is no client terminal 5 capable of carrying out a wireless communication (S302: No), the controller unit 26 repeats Act S302.

If there is a client terminal 5 capable of carrying out a wireless communication (S302: Yes), the controller unit 26 sends, through the wireless communication via the LCX cable 3, the client terminal 5 query data querying whether or not it is desired to send a coupon (Act S303). After receiving the query data, the client terminal 5 displays, on the display thereof, such a message as ‘whether or not it is desired to send a coupon’, and then accepts a selection ‘send/not send’ based on the operation on the operation unit thereof. If such a selection is made by the user, the client terminal 5 responds a selection result.

When the access point 1 receives the selection result, the controller unit 26 determines whether or not the result is a result ‘it is required (desired) to send a coupon’ (Act S304). If the result is ‘it is required (desired) to send a coupon’ (Act S304: Yes), the controller unit 26 sends an electronic coupon to the client terminal 5 initiating the request through the wireless communication via the LCX cable 3 (Act S305).

If the result is not ‘it is not required (desired) to send a coupon’ (Act S304: No), the controller unit 2 returns to execute Act S302 to determine whether or not there is another client terminal 5 capable of carrying out a communication and, if there is such a client terminal 5, carry out the processing following Act S303 by taking the client terminal 5 as an object.

The electronic coupon sent to the client terminal 5 is shown to the cashier when a checkout processing is carried out by the POS terminal 40.

Thus, it is assumed in this embodiment that the power supply of the access point 1 is also switched on when a checkout processing is being carried out by the POS terminal 40 in the case where a person is detected by the human body sensor 27. In this way, the LCX electrode 100 is activated by taking more specific conditions of the surroundings of the checkout counter equipped with the POS terminal 40 into consideration.

In this embodiment, the arrangement of the LCX electrode 100 around the checkout counter in a shop makes checkout-waiting customers feel more comfortable.

Due to the dispensing of coupons, the customer waiting for a checkout may obtain a coupon, which prevents the generation of a degraded shop impression by a long checkout-waiting time and attracts more customers.

The device described in this embodiment achieves the same effect as that described in the first embodiment.

### The Third Embodiment

The third embodiment is described below.

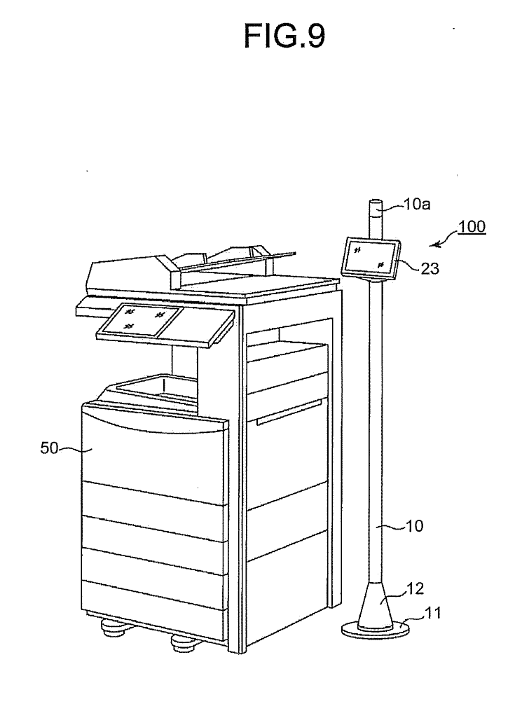

In this embodiment, the LCX electrode 100 is arranged around an MFP50 in a convenience store, and each device of the LCX electrode 100 is driven according to the detection result of the human body sensor 27 or the action condition of the MFP50, as exemplarily shown in FIG. 9.

The human body sensor 27 described in this embodiment is pre-arranged to detect the customer passing the entrance of a shop.

The MFP 50 functions to realize a color or black and white copy service, a network printing service of printing the data stored in a mail server connected with the Internet as well as a FAX sending/receiving service.

The network printing service is realized by, for example, the following acts. First, the sender sends mail data to a predetermined mail address. At this time, the fixed file number of the sender is informed from the side of the mail receiver (the side of network printing service provider), and the sent mail data is stored in the server of the service provider. The mail receiver acquires the file number from the sender and inputs the number into the MFP 50. Then, the MFP 50 receives the mail data that is stored in the server of the server and then prints the data.

The FAX receiving service is realized by, for example, the following acts. First, the sender sends printing data to a predetermined FAX with a dedicated FAX number. At this time, the fixed file number of the sender is informed from the side of the FAX receiver (the side of the FAX receiving servant), and the sent FAX data is stored in the server of the servant. The FAX receiver acquires the file number from the sender and inputs the number into the MFP 50. Then, the MFP 50 receives the FAX data that is stored in the server of the server and prints the data.

The actions involved in the control over the power supply of the access point 1 are substantially identical to those shown in the flow chart of FIG. 7.

In the flow shown in FIG. 7, in act 202, the controller unit 26 determines, using the MFP 50, whether or not a processing related to the copy service, the network printing service and the FAX sending/receiving service is being carried out. The determination may also be carried out based on whether or not a notice is received that is sent from the MFP 50 to notify the controller unit 26 to start or end the processing related to the copy service, the network printing service and the FAX sending/receiving service.

If no people is detected by the human body sensor 27 (S201: No) and no processing related to the copy service, the network printing service and the FAX sending/receiving service is being carried out (Act 202: No), the controller unit 26 switches off the power supply of the access point 1 (Act S203) and returns to execute Act S201.

If a person is detected by the human body sensor 27 (S201: Yes) and a processing related to the copy service, the network printing service and the FAX sending/receiving service is being carried out (Act 202: Yes), the controller unit 26 switches on the power supply of the access point 1 (Act S204). At this time, the access point 1 starts to supply power to the LCX cable 3, the LED indicator light 20, the aroma diffuser 21, the Picoion generator 22 and the display 23, the client terminal 5 hold by the customer operating the MFP 50 can wirelessly communicate with the LCX cable to lighten the LED indicator light 20, the aroma diffuser 21 sprays essential oil to the surroundings, the Picoion generator 22 generates Picoions, and the display 23 displays various kinds of information. Then, Acts S205 and S206 are executed.

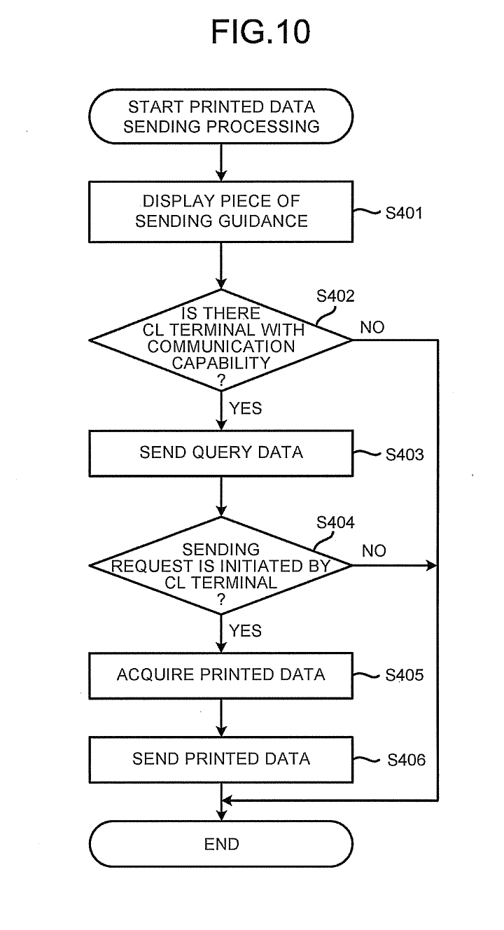

In this embodiment, the printed data sending processing shown in the flow chart of FIG. 10 is carried out by the controller unit 26 when the copy service, the network printing service and the FAX sending/receiving service is carried out.

During the printed data sending processing, first, the controller unit 26 enables the display 23 to display a message ‘the printed data can be sent’ and a piece of guidance to a receiving method (Act S401).

The controller unit 26 confirms the communication condition of the access point 1, and determines whether or not there is a client terminal 5 that can wirelessly communicate with the LCX cable 3 via the access point 1 (Act S402). In this determination, for instance, assume a beacon is sent from the LCX cable 3, the existence of a client terminal 5 capable of carrying out a wireless communication can be determined if a response to the beacon is obtained from the client terminal 5, otherwise, the absence of such a client terminal can be determined.

If there is no client terminal 5 capable of carrying out a communication (S402: No), the controller unit 26 ends the printed data sending processing.

On the other hand, if there is a client terminal 5 capable of carrying out a communication (S402: Yes), the controller unit 26 sends, through the wireless communication via the LCX cable 3, query data to the client terminal 5 to query whether or not it is desired to send the printed data (Act S403). After receiving the query data, the client terminal 5 displays, on the display thereof, such a message as ‘whether or not it is desired to send the printed data’, and then accepts a selection ‘send/not send’ based on the operation on the operation unit thereof. If such a selection is made by the user, the client terminal 5 responds a result to the selection.

When the access point 1 receives the selection result, the controller unit 26 determines whether or not the result is ‘it is required (desired) to send the printed data’ (Act S404). If the result is not ‘it is required (desired) to send the printed data’ (Act 404: No), the controller unit 25 ends the printed data sending processing.

On the other hand, if the result is ‘it is required (desired) to send the printed data’ (Act 404: Yes), the controller unit 25 acquires the printed data from the MFP 50. If the processing being carried out is a processing related to the copy service or FAX sending service, then the printed data is the copied data read by the scanner of the MFP 50; if the processing being carried out is a processing related to the network printing service, then the printed data is the mail data received by the MFP 50 from a server; and if the processing being carried out is a processing related to the FAX receiving service, then the printed data is the FAX data received by the MFP 50 from a server.

After acquiring the printed data, the controller unit 26 sends, through a wireless communication via the LCX cable 3, the printed data to the client terminal 5 requiring the sending (Act S406) and then ends the printed data sending processing.

Thus, it is assumed in this embodiment that the power supply of the access point 1 is also switched on when a processing related to the copying service, the network printing service or the FAX sending/receiving service is being carried out by the MFP 50 in the case where a person is detected by the human body sensor 27. In this way, the LCX electrode 100 is activated by taking more specific conditions of a shop equipped with the MFP 50 into consideration.

In this embodiment, the arrangement of the LCX electrode 100 adjacent to the MFP 50 provides a comfortable operation experience for the operator operating the MFP 50.

By means of the printed data sending processing, the data printed by the MFP 50 can be printed on a paper medium or acquired in the form of electronic data.

The device described in this embodiment achieves the same effect as that described in the first embodiment.

### The Fourth Embodiment

The fourth embodiment is described below.

In this embodiment, it is exemplarily shown the drive of each device of the LCX electrode 100 according to the crowding condition of the people nearby the LCX electrode 100 in the wireless communication system shown in embodiments 1-3.

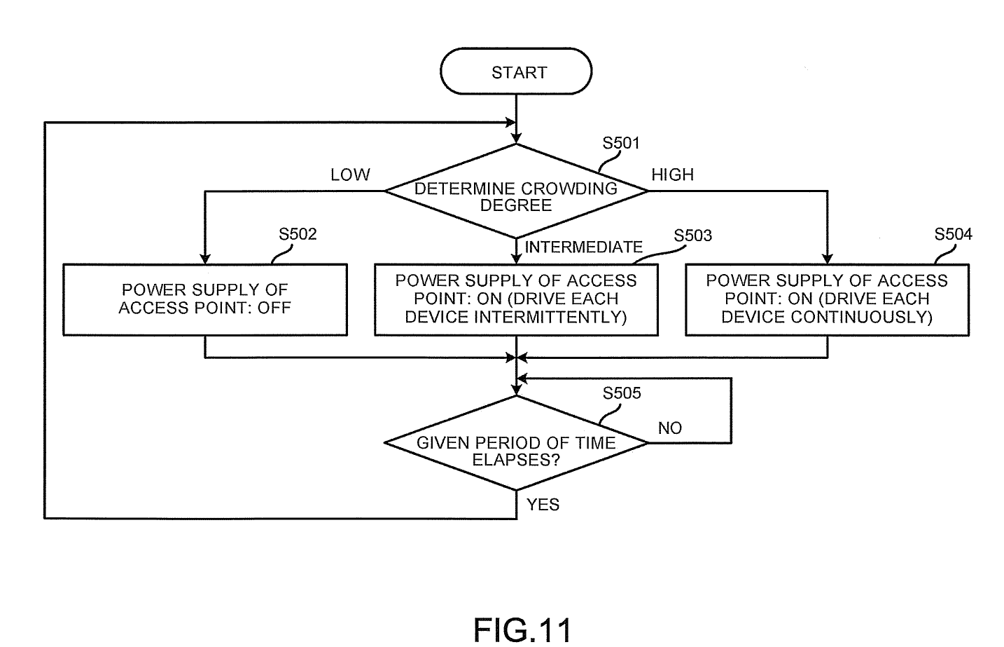

FIG. 11 is a flow chart showing the actions carried out by the controller unit 26 in this embodiment.

As shown in FIG. 11, first, the controller unit 26 divides the crowding degree of the people around the LCX electrode 100 to three levels: ‘low’, ‘intermediate’ and ‘high’ (Act S501).

This determination may also be carried out based on the detection result of the human body sensor 27. That is, the human body sensor 27 may be arranged to detect the number of the people around the LCX electrode 100, assume the crowding degree is ‘low’ when the detected number P is smaller than a threshold P1 (P<P1), ‘intermediate’ when the detected number P is greater than or equal to the threshold P1 but smaller than a threshold P2 (P1≦P<P2), and ‘high’ when the detected number P is greater than or equal to the threshold P2 (P2≦P). Further, the human body sensor 27 comprises a camera for shooting the surroundings of the LCX electrode 100 and a device that accumulates the faces contained in the image shot by the camera, thereby detecting the number of the people around the LCX electrode 100.

The determination may also be carried out according to the use condition of an external machine such as the POS terminal 40 or MFP 50. That is, the controller unit 26 is activated to measure the quantity of the processing related to a checkout processing or copy service carried out in per time unit, and it is assumed that the crowding degree is ‘low’ when the detected number Q is smaller than a threshold Q1 (Q<Q1), ‘intermediate’ when the detected number Q is greater than or equal to the threshold Q1 but smaller than a threshold Q2 (Q1≦Q<Q2), or ‘high’ when the detected number Q is greater than or equal to the threshold Q2 Q2≦Q).

This determination is carried out based on the detection result of the human body sensor 27 as well as the use condition of the external machine.

According to the determination result, the controller unit 26 switches off the power supply of the access point 1 (Act S502) when the crowding degree is ‘low’ (Act S501: Low).

In addition, according to the determination result, the controller unit 26 intermittently switches on the power supply of the access point 1 (Act S503) when the crowding degree is ‘intermediate’ (Act S501: Intermediate). In this way, power is intermittently supplied from the access point 1 to the LCX cable 3, the LED indicator light 20, the aroma diffuser 21, the Picoion generator 22 and the display 23, each of which acts when powered at given time. In order to maintain an excellent wireless communication environment, the LCX cable 3 may be continuously supplied with power.

In addition, according to the determination result, the controller unit 26 continuously switches on the power supply of the access point 1 (Act S504) when the crowding degree is ‘high’ (Act S501: High), as it does in embodiments 1-3. In this way, power is continuously supplied from the access point 1 to the LCX cable 3, the LED indicator light 20, the aroma diffuser 21, the Picoion generator 22 and the display 23, each of which acts then.

After any one of Acts S502-504 is executed, the controller unit 26 waits for a given period of time with reference to the time timed by a timer (not shown) (Act S505: No). After a given period of time elapses (Act S505: Yes), the controller unit 26 returns to execute Act S501 to re-determine the crowding degree and then acts according to the result of the determination.

The actions described in this embodiment are applicable to any one of the use modes of the LCX electrode 100 described in embodiments 1-3.

In this way, each device of the LCX electrode 100 acts according to the crowding degree of the people nearby the LCX electrode 100 in this embodiment. Thus, each device is activated according to the actual condition.

The device described in this embodiment achieves the same effect as those described in embodiments 1-3.

A novel wireless communication system is provided in the above-described embodiments 1-4 that is equipped with and uses a vertically arranged LCX cable 3. In addition, a comfortable space is provided to the user of the wireless communication system by arranging the LED indicator light 20, the aroma diffuser 21, the Picoion generator 22 and the display 23 and controlling them according to the detection result of the human body sensor 27 or the use condition of the external machine.

### Variation Embodiment

When in implementation, the structure disclosed in each above-described embodiment may be embodied by modifying each structural member appropriately.

In each above-described embodiment it is exemplarily shown the vertical arrangement of the LCX electrode on the table or the arrangement of the LCX electrode nearby the POS terminal or MFP. However, the structure disclosed in each above-described embodiment is applicable to various cases in which the external machine may be, for example, an indoor light, an ECR (Electric Cash Register), a self-help POS terminal, a card settlement terminal specialized in settlement with card, various ticket dispensers, an ATM (Automatic Teller Machine) or various other machines.

The member for vertically arranging the LCX cable 3 on the setting surface may by other members, but not limited to the cover member 10 or the support base unit 11. For instance, the cover member 10 may be installed on a table or floor surface serving as a setting surface without using the support base unit 11 so as to vertically arrange the LCX cable 3 on the setting surface.

It is assumed in the embodiments above that the controller unit 26 controls each device by executing the computer programs stored in the memory thereof with a CPU. However, the present invention is not limited to this, the programs may also be downloaded to the controller unit 26 from a given network, or a program for storing the same function in a storage medium is installed in the controller unit 26. The storage medium may be a CD-ROM or USB memory, and any other form readable to a device built in or connected with the controller unit 26. Further, the function achieved by an installed or downloaded program may also be achieved through cooperation with the operating system installed in the controller unit 26 in the device.

It is assumed in the embodiments above that the LED indicator light 20 is lightened to inform the user of the action state of the wireless communication system. However, in addition to informing the user of the action state of the wireless communication system, the LED indicator light 20 may also function as an illuminator. In this case, one part of the plurality of LED indicator lights 20 may function to inform the user of the action state of the wireless communication system while the other function as an illuminator.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication system, comprising:
a leaky coaxial cable configured to send and receive electric wave to and from a wireless communication terminal; and
a retainer member configured to vertically arrange the leaky coaxial cable on a given setting surface.

2. The wireless communication system according to claim 1, wherein
the retainer member includes:
a hollow cover member configured to store the leaky coaxial cable; and
a support base unit configured to vertically arrange the hollow cover member on the setting surface so as to make the axial direction of the leaky coaxial cable stored in the hollow cover member vertical to the setting surface.

3. The wireless communication system according to claim 2, wherein
one end of the leaky coaxial cable is connected with a base station which controls sending and receiving electric wave via the leaky coaxial cable and the other end of the leaky coaxial cable is connected with a terminator; and
the base station and the terminator are stored in the hollow cover member.

4. The wireless communication system according to claim 2, further comprising:
a device that is different from the leaky coaxial cable and arranged on the hollow cover member; and
a control unit configured to control the action of the device.

5. The wireless communication system according to claim 4, further comprising:
a sensor configured to detect the existence of a person; wherein
the control unit controls the action of the device according to the detection result of the sensor.

6. The wireless communication system according to claim 4, wherein
an external machine is connected with the control unit; and
the control unit controls the action of the device according to the use condition of the external machine.
